(19) United States
(12) Patent Application Publication
(10) Pub. No.: US 2016/0037469 A1
(43) Pub. Date: Feb. 4, 2016

(54) SYSTEM AND METHOD FOR ESTABLISHING AN AD HOC NETWORK HAVING A DESIGNATED DATA EXCHANGE PROTOCOL

(71) Applicant: Skirmos LLC, Silver Spring, MD (US)

(72) Inventors: George William Smith, Silver Spring, MD (US); Ibrahim Pasha, Takoma Park, MD (US); Allen Ivanov, Mukilteo, WA (US); Richard Rice, Silver Spring, MD (US)

(21) Appl. No.: 14/816,467

(22) Filed: Aug. 3, 2015

Related U.S. Application Data
(60) Provisional application No. 62/031,967, filed on Aug. 1, 2014.

(51) Int. Cl. H04W 56/00; A63F 13/837; A63F 13/44; A63F 13/46; A63F 13/73; A63F 13/35; H04L 29/06; A63F 13/235

(52) U.S. Cl. CPC H04W 56/0025; H04L 65/4076; A63F 13/837; A63F 13/235; A63F 13/46; A63F 13/73; A63F 13/35; A63F 13/44; H04W 84/18

(57) ABSTRACT

A mobile device includes a memory, a wireless communication module, and a programmable processor operatively coupled together. The wireless communication module is configured to communicate within an ad hoc network with other mobile devices by wireless broadcasting. The programmable processor is instructed by computer executable code to: initiate an ad hoc network by self-identifying as a host device; receive requests to join the ad hoc network from participating mobile devices; assign a unique identifier to each of the host device and the participating mobile devices, the unique identifiers identifying the host device and the participating mobile devices as network participants; distribute to the participating mobile devices a list of the network participants, the list including the assigned unique identifiers; confirm receipt of the participant list by each of the participating mobile devices; and designate to the participating mobile devices a data exchange protocol for the ad hoc network.

### CROSS REFERENCE TO RELATED APPLICATIONS

Priority is claimed to U.S. provisional patent application No. 62/031,967, filed Aug. 1, 2014, the disclosure of which is incorporated herein by reference in its entirety.

### FIELD OF THE INVENTION

The field of the present invention relates to is systems and methods for establishing an ad hoc network having a designated data exchange protocol, particularly ad hoc networks and data synchronization protocols which are useful in the area of laser tag game play for synchronization and tracking of scoring.

### BACKGROUND OF THE INVENTION

In certain recreational games, it is recognized that communication between equipment used by the players is advantageous to the flow of the game. One such game is laser tag. Traditionally, laser tag guns have used infrared transmitters/receivers to exchange data, and particularly to synchronize score keeping amongst the various laser tag guns used in a given game. The problem with infrared transmitters/receivers, however, is that they require a direct line of site between two respective laser tag guns in order to be able to exchange data. As anyone who has played laser tag would recognize, establishing a direct line of site between two players for purposes of communication between game equipment, other than for shooting between players, can often be a problem. Attempts have been made to mix the realms of modern wireless networking with laser tag guns, resulting in laser tag guns which wirelessly communicate with a base station, with the base station acting as network host or base node for the laser tag guns. While this marriage of wireless network-capable laser tag guns and base station is a significant improvement over laser tag guns communicating using infrared, an entirely new problem has been introduced to the game—the laser tag guns are now tethered to the base station, and they lose some very desirable functionality when used without a base station.

As with other wireless communication devices, it would be desirable to enable laser tag guns to be used as part of an ad hoc network. However, by eliminating the base station, a source of processing capabilities and game management is removed from the game network. Two of the main game management functions of the base station include message routing between laser tag guns and score keeping, and a simple substitution of an ad hoc network for the base station network does not adequately replace these game management functions. For example, a base station may be aware that one of the laser tag guns is out of range for purposes of updating messaging and score keeping, but in an ad hoc network, managing messaging and score keeping when one laser tag gun moves out of range presents problems for which no acceptable solutions have yet been advanced in the prior art. Thus, although in some ways ad hoc networks have become quite advanced, there still exists a need for adequate replication of omitted infrastructure, such as the base station for laser tag games, which is not utilized as part of an ad hoc network.

### SUMMARY OF THE INVENTION

The present invention is directed toward a system and method for establishing an ad hoc network, and particularly an ad hoc network having a designated data exchange protocol which readily enables messaging and/or data synchronization between network participants (also commonly referred to as nodes). The system and method provide for the establishment of an ad hoc network in such a way that the messaging and/or data synchronization protocols may be established amongst the network participants at the time the ad hoc

In a first separate aspect of the present invention, a mobile device includes: a memory; a wireless communication module configured to communicate within an ad hoc network with other mobile devices by wireless broadcasting; a programmable processor operatively coupled to the memory and to the wireless communication module and configured to execute non-transitory computer-executable code, the code instructing the programmable processor to: initiate an ad hoc network by self-identifying as a host device for the ad hoc network; receive, through wireless broadcasting, one or more requests to join the ad hoc network from one or more participating mobile devices of the other mobile devices; assign a unique identifier to each of the host device and the one or more participating mobile devices, the unique identifiers identifying the host device and the one or more participating mobile devices as network participants; distribute to the one or more participating mobile devices, through wireless broadcasting, a list of the network participants, the list including the assigned unique identifiers; confirm, through wireless broadcasting received from each of the one or more participating mobile devices, receipt of the participant list by each of the one or more participating mobile devices; and designate to the one or more participating mobile devices, through wireless broadcasting, a data exchange protocol for the ad hoc network.

In a second separate embodiment of the present invention, a method of establishing an ad hoc network amongst a plurality of mobile devices, each mobile device comprising a wireless communication module configured to enable communications through wireless broadcasting between at least any two of the plurality of mobile devices, the method including: identifying a first mobile device among the plurality of mobile devices as a host device for the ad hoc network; receiving, by the first mobile device through receipt of wireless broadcasting, a request to join the ad hoc network from one or more participating mobile devices of the plurality of mobile devices; assigning, by the first mobile device, a unique identifier to each of the first mobile device and the one or more participating mobile devices, the unique identifiers identifying the first mobile device and the one or more participating mobile devices as network participants; distributing to the one or more participating mobile devices, by the first mobile device through wireless broadcasting, a list of the network participants, the list including the assigned unique identifiers; and confirming, by the first mobile device through wireless broadcasting received from each of the one or more participating mobile devices, receipt of the participant list by each of the one or more participating mobile devices; and designating to the one or more participating mobile devices, through wireless broadcasting, a data exchange protocol for the ad hoc network.

In a third separate aspect of the present invention, a mobile device includes: a memory; a wireless communication module configured to communicate with other mobile devices by wireless broadcasting, the mobile device and the other mobile devices being configured to join an ad hoc network as network participants; a programmable processor operatively coupled to the memory and to the wireless communication module and configured to execute non-transitory computer-executable code, wherein once joined in the ad hoc network, the code instructs the programmable processor to: transmit a message to the other network participants of the ad hoc network through wireless broadcasting; receive one or more receipt acknowledgement messages through wireless broadcasting in response to the transmitted message, each receipt acknowledgement message indicating receipt of the message by one of the other network participants; maintain a record of received receipt acknowledgement messages; and retransmit the message, through wireless broadcasting, following a time interval until the record indicates that the message has been received by each of the other network participants.

Accordingly, an improved system and method for establishing an ad hoc network are disclosed. Advantages of the improvements will be apparent from the drawings and the description herein.

### BRIEF DESCRIPTION OF THE DRAWINGS

The foregoing summary, as well as the following detailed description of the exemplary embodiments, will be better understood when read in conjunction with the appended drawings. It should be understood, however, that the invention is not limited to the precise arrangements and instrumentalities shown in the following figures:

FIG. 1 schematically illustrates a mobile device for executing code to establish and participate in an ad hoc network;

FIG. 2 is a schematic representation of laser tag guns within an ad hoc network;

FIG. 3 is a flowchart showing a process of initiating an ad hoc network;

FIG. 4 is a flowchart showing a message transmitting protocol within an ad hoc network;

FIG. 5 is a flowchart showing a message receiving protocol within an ad hoc network; and

FIG. 6 is a flowchart showing an alternative message receiving protocol within an ad hoc network.

### DETAILED DESCRIPTION OF THE INVENTION

Features of the present invention may be implemented in software, hardware, firmware, or combinations thereof. The programming processes described herein are not limited to any particular embodiment, and may be implemented in an operating system, application program, foreground or background processes, driver, or any combination thereof. The programming processes may be compiled as executable code to be executed on a single programmable processor or multiple programmable processors.

The programmable processors described herein may be any central processing unit (CPU), microprocessor, micro-controller, computational, or programmable device or circuit configured for executing programming processes (e.g., executable code). Various processors may be embodied in any suitable type of hardware and may include all the usual ancillary components necessary to form a functional data processing and communication device including without limitation a bus, software and data storage such as volatile and non-volatile memory, input/output devices, graphical user interfaces (GUIs), removable data storage, and wired and/or wireless communication interface devices including Wi-Fi, Bluetooth, LAN, without limitation, unless expressly recited in the claims.

Computer-executable instructions or programs (e.g. software or code) and data described herein may be programmed into and tangibly embodied in a non-transitory computer-readable medium that is accessible to and retrievable by a respective processor as described herein which configures and directs the processor to perform the desired functions and processes by executing the instructions encoded in the medium. A device embodying a programmable processor configured to such non-transitory computer-executable instructions or programs is referred to hereinafter as a “programmable device”, or just a “device” for short. It should be noted that non-transitory “computer-readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g. internal/external hard disks, floppy discs, magnetic tape CD-ROM, DVD-ROM, optical disk, ZIP™ drive, Blu-ray disk, and others), which may be written to and/or read by a processor operably connected to the medium.

In certain embodiments, the present invention may be embodied in the form of computer-implemented processes and apparatuses such as processor-based data processing and communication systems or computer systems for practicing those processes. The present invention may also be embodied in the form of software or computer program code embodied in a non-transitory computer-readable storage medium, which when loaded into and executed by the data processing and communications systems or computer systems, the computer program code segments configure the processor to create specific logic circuits configured for implementing the processes.

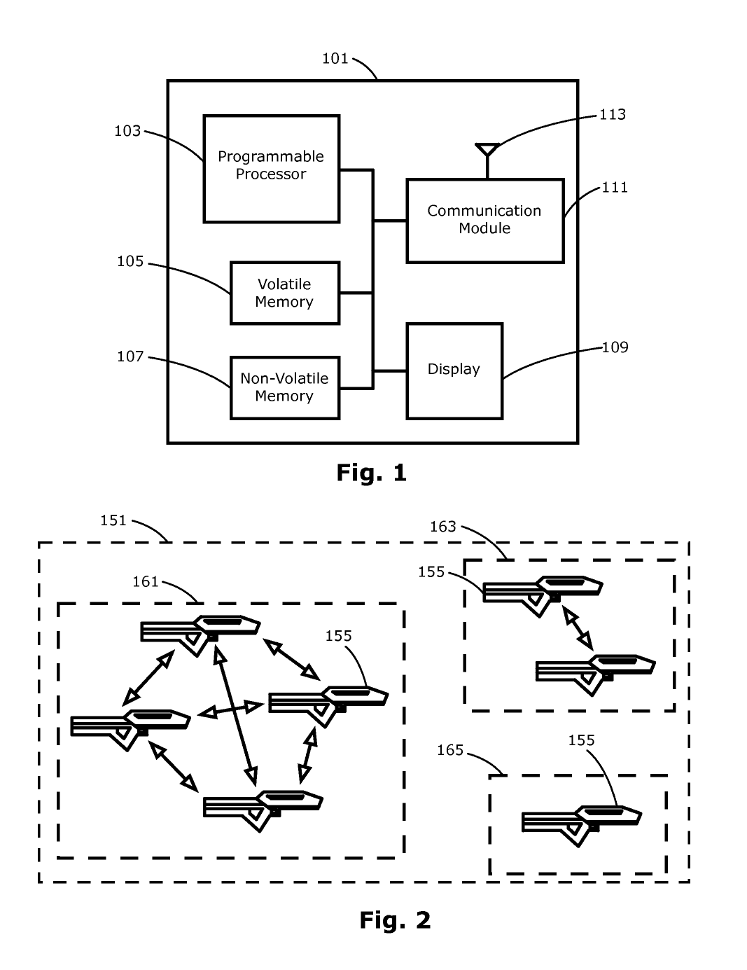

An exemplary mobile device 101 is shown in FIG. 1. The mobile device 101 includes a programmable processor 103, a volatile memory 105, a non-volatile memory 107, a display 109, and a communications module 111. Other features common to mobile programmable devices may also be included with the mobile device 101, such as a power switch, buttons and/or switches to indicate settings and/or interact with the software, an audio speaker, and audio out, or a wired communication port, such as USB, USB2, or any other type of wired communication technology. The non-volatile memory 107 is used by the programmable processor 103 to store executable code for instructing the programmable processor 103 to perform the functions described herein. The non-volatile memory 107 may also be used by the programmable processor 103 to store operational settings, user information, data, and any other information that may be desirable to store long term for use with the mobile device 101. The volatile memory 105 may be used by the programmable processor 103 to store transitory data, e.g., data that is needed only at the time of a particular use and that may be erased by the programmable processor 103 without impairing functionality of the mobile device 101.

The display 109 may be an LCD, OLED, or other similar type of display. In certain embodiments, the display 109 may be a touch sensitive display which allows the user to interact with the software through the display 109 itself. In certain embodiments, the display 109 may simply be a plurality of LEDs arranged to provide the user of the mobile device 101 with particular types of information, and in such embodiments, the information may be indicated by the number, colors, position, and/or arrangement of LEDs which are illuminated at a given time, or it may be indicated by written labels placed next to the LEDs.

The communication module 111 is operationally coupled to an appropriate antenna 113 and includes a radio frequency (RF) transceiver configured for wireless transmitting and receiving modulated RF signals at one or more radio frequencies. The communication module 111 is therefore configured for wireless communications with other devices. In the embodiments described herein, the functionality of the ad hoc network is enabled through broadcast of the modulated RF signals to other mobile devices 101, as opposed the RF signals being unicast or multicast. Even so, in certain embodiments, the mobile device 101 may also be configured to unicast or multicast communications with other mobile devices 101. For communications between multiple mobile devices 101, the frequency or frequencies used are a matter of design choice. In order to establish an ad hoc network, different mobile devices 101 need to be able to communicate on at least one common frequency. Having a communication module 111 which is capable of communicating through broadcast radio communications using multiple radio frequencies is therefore advantageous for implementation one or more of the features of an ad hoc network that are described below.

In the following description, the establishment of an ad hoc network and protocols used once an ad hoc network is established are described within the context of a laser tag game. Many of the features and functionality discussed, however, will have wider applicability to ad hoc networks outside of the context of a laser tag game. As such, unless otherwise expressly recited in the claims, the invention is not to be limited to a laser tag game, nor are the mobile devices 111 to be limited to laser tag guns.

FIG. 2 schematically illustrates a snapshot in time of an ad hoc network 151 between a plurality of laser tag guns 155, the ad hoc network 151 having been previously established between the plurality of laser tag guns 155 as part of a laser tag game. Each laser tag gun 155 is configured as described for the mobile device 111 of FIG. 1, each broadcasts (as opposed to unicast or multicast) RF signals to communicate with the other laser tag guns 155 of the ad hoc network 151. In addition, each laser tag gun 155 includes other components which allow it to function within the game of laser tag, such as an infrared laser emitter, an infrared detector, and a trigger mechanism to actuate the laser emitter, none of which are shown, as they are typical of laser tag guns commonly found on the market. As is practiced in the prior art through different systems and methods that employ infrastructure, such as base stations, it is desirable within a game of laser tag that all the laser tag guns are able to share and synchronize data during the course of the game. In the prior art, the base station, or other non-mobile infrastructure, enables the data sharing and synchronization to facilitate the game of laser tag. As described herein, the ad hoc network is configured at the outset, and uses certain proscribed data exchange protocols, in order to replicate the data sharing and synchronization capabilities enabled by base stations of the prior art. Moreover, certain of the data exchange protocols described below allow the laser tag guns 155 incorporated into an ad hoc network 151 to share and synchronize data even when one or more of the laser tag guns 155 has previously traveled out of range of all other laser tag guns 155 and subsequently returned into range of at least one other laser tag gun 155 within the ad hoc network 151.

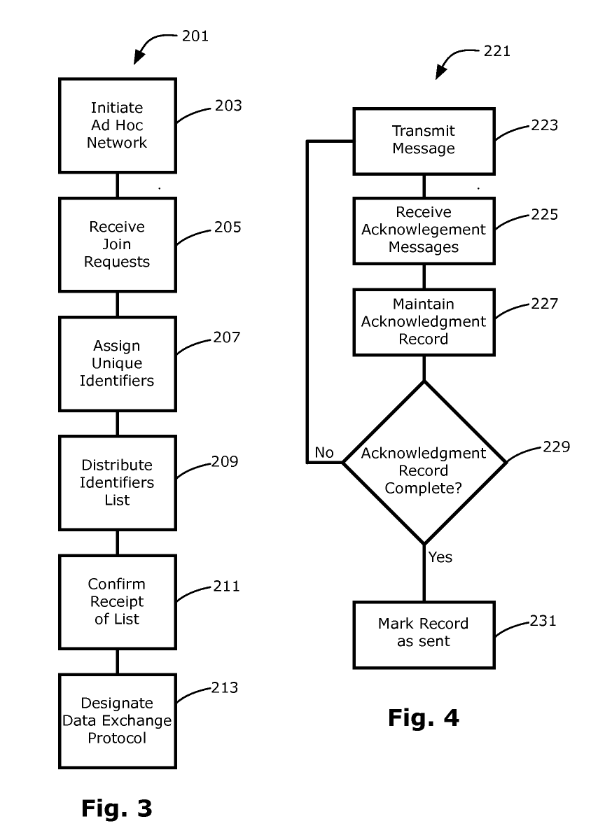

The circumstances of the ad hoc network 151 shown in FIG. 2 are referenced as part of the ensuing functionality description associated with FIGS. 3-6. As shown in FIG. 2, the plurality of laser tag guns 155 are all part of the ad hoc network 151. The ad hoc network 151 includes, within the snapshot of time shown, a first group 161 of four laser tag guns 155, a second group 163 of two laser tag guns 155, and a third group 165 of one laser tag gun 155. The number of laser tag guns 155 shown in each group 161, 163, 165 is for example purposes only, and is in no way intended to limit the scope of the invention. Within the first group 161, all of the laser tag guns 155 are within range of one another, such that each of these laser tag guns 155 are able to actively communicate with each other. Within the second group 163, both of the laser tag guns 155 are within range of one another, such that each of these laser tag guns 155 is able to actively communicate with the other laser tag gun 155. However, the first group 161 of laser tag guns 155 is out of range from the second group 163 of laser tag guns 155, so that none of the laser tag guns 155 in the first group 161 are able to actively communicate with the laser tag guns 155 in the second group 163. The laser tag gun 155 in the third group 165 is out of range of all other laser tag guns 155, and therefore is not able to communicate with any other laser tag guns 155. Because a laser tag game may involve much movement by the players, and thus also by the laser tag guns 155, the groupings shown are subject to change over time as the game progresses.

Once the ad hoc network 151 is established, by the process described below, even when one or more of the laser tag guns 155 are out of range of other laser tag guns 155 (e.g., the laser tag guns 155 of group 163 and/or 165), game play can still continue smoothly. Through one or more of the processes below, when an out-of-range laser tag gun 155 once again comes within range of at least one other laser tag gun 155 within the ad hoc network 151, messages can be delivered to the previously out-of-range laser tag gun 155 and game score data, which is kept by all laser tag guns 155 within the ad hoc network 151, can be synchronized as between all laser tag guns 155 of the ad hoc network 151 that are currently within broadcast range of one another, including the previously out-of-range laser tag gun 155. Thus, the laser tag game is more robust, as the game is able continue even when one or more of the laser tag guns 155 goes out of range of the other laser tag guns 155.

Each of the laser tag guns 155 shown in FIG. 2 is programmed with software which enables them, as a group of the mobile devices 101, to establish the ad hoc network 151 amongst all laser tag guns 155 that are involved in game play (referred to herein as “network participants”). Each laser tag gun 155 is also programmed with software which enables information to be sent and synchronized between the several laser tag guns 155 through the respective wireless communication module of each laser tag gun 155. Each of these functional aspects of the laser tag guns 155, both individually and as a collective within an ad hoc network 151, is described in greater detail below.

The process 201 of establishing an ad hoc network 151 amongst a plurality of laser tag guns 155 (configured as the mobile device 101 of FIG. 1) is illustrated in the flowchart of FIG. 3. The first step of the process is for one laser tag gun 155, out of the collection of laser tag guns 155, to initiate 203 the ad hoc network 151. The laser tag gun 155 performing the initialization process is referred to as the host device, and any one of the laser tag guns 155 may be selected to serve as the host device. Following the initialization process, the ad hoc network 151 does not differentiate between the laser tag gun 155 which served as the host device and any of the other laser tag guns 155 that are network particpants. In fact, following the initialization process of the ad hoc network 151, the laser tag gun 155 that is the host device could drop out of the network (e.g. by traveling out of range, by powering off, etc.), and communications between the remaining laser tag guns 155 would remain unaffected. This is because, once the ad hoc network 151 is established, there is no single laser tag gun 155 in charge of organizing the game data, not even the laser tag gun 155 that served as the host device.

In the context of a laser tag game, when players want to start a game, one laser tag gun 155 is chosen, by self-identification, to be the host device. Self-identification of the host device may be as simple as the user pressing a button, actuating a switch, or if the display is a touch-sensitive display, making a selection on the display to indicate that a particular laser tag gun 155 should act as the host device for initializing an ad hoc network 151. The laser tag gun 155 that is the host device may actively broadcast to other nearby laser tag guns 155 that a laser tag game is being initiated, or alternatively the laser tag gun 155 which is selected as the host device may passively wait for other laser tag guns 155 to broadcast a request to join the ad hoc network 151 being initialized. Regardless, the laser tag gun 155 that is the host device receives requests 205 from other nearby laser tag guns 155 to join the ad hoc network 151. Each laser tag gun 151 that broadcasts a request to join the initiated ad hoc network 151 is referred to as a participating mobile device at this stage of initiating the ad hoc network 151. Once the ad hoc network 151 is fully established, then the network participants include the laser tag gun 155 that served as the host device along with the laser tag guns 155 that sent requests to join the ad hoc network as participating mobile devices.

The laser tag gun 155 that is the host device may determine when to effectively “close” the ad hoc network 151. Closing the ad hoc network 151 may occur when the laser tag gun 155 that is the host device (or the user of the host device) determines that the laser tag game has enough participants, or alternatively when a determination is made that all laser tag guns 155 with users intending to join the ad hoc network 151 have broadcast a join request. Other criteria may also be used for determining when to close an ad hoc network 151.

As each participating laser tag gun 155 submits the join request, or alternatively after all join requests have been received and the ad hoc network 151 is effectively closed to new participants, the laser tag gun 155 that is the host device assigns unique identifiers 207 to each laser tag gun 155 participating in the ad hoc network 151, including the laser tag gun 155 that is the host device itself. A list or table of the assigned unique identifiers is then distributed 209 by the laser tag gun 155 that is the host device to each of the other laser tag guns 155 that are participating devices. This list identifies every laser tag gun 155 that is a network participant within the ad hoc network 151. Moreover, within the context of the ad hoc network 151, each network participant becomes a node within the ad hoc network 151. The laser tag gun 155 that is the host device also confirms receipt of the distributed list 211 by each of the other laser tag guns 155 that are network participants. Receipt confirmation may be achieved by a simple acknowledgement message sent from each of the other laser tag guns 155 to the laser tag gun 155 that is the host device.

A final step in the establishment of the ad hoc network 151 is for the laser tag gun 155 that is the host device to designate a data exchange protocol 213 to the other participating laser tag guns 155. The designation of the data exchange protocol 213 may be achieved in a variety of ways, such as by providing a protocol identifier to the other laser tag guns 155 that are network participants, by distributing the data exchange protocol itself, or by identifying or distributing a game format or game rules for the laser tag game that is to be played. Other methods of designating the data exchange protocol 213 may also be used. By having the data exchange protocol 213 designated at the time the ad hoc network 151 is established, the ad hoc network 151 is better able to serve the needs of the different types of laser tag games that may be played. Depending upon the implementation for designating the data exchange protocol 213, every laser tag gun 151 may not need to be pre-programmed for a particular game type. This manner of designating the data exchange protocol 213 also allows for new types of laser tag games to be developed and implemented without requiring wholesale change to the design of the ad hoc network 151.

Once the ad hoc network 151 is established, the laser tag gun 155 that is the host device communicates to the other laser tag guns 155 when the game is to start. FIG. 4 shows a flowchart for a messaging protocol 221 between laser tag guns 155 during game play. Although a particular messaging protocol is being disclosed, the invention is not intended to be limited to any particular messaging protocol unless otherwise expressly recited in the claims.

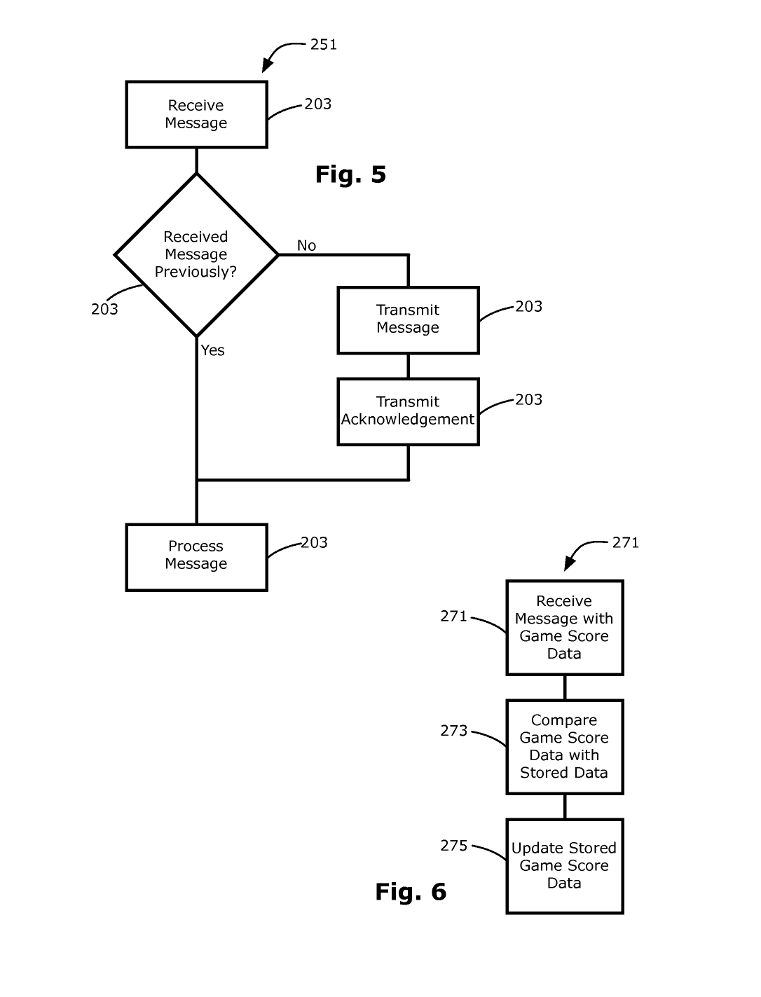

The messaging protocol 221 of FIG. 4 is referred to as “sender-makes-right,” as the laser tag gun 155 that is sending the message bears the responsibility to ensure that all the other laser tag guns 155 within the ad hoc network 151 receive the message. As a first step in this messaging protocol 221, the sending laser tag gun 155 transmits the message 223 as a broadcast to the other guns on the ad hoc network 151. The message is kept in memory by the sending laser tag gun 155 until such time as the sending laser tag gun 155 has determined that all other laser tag guns 155 within the ad hoc network 151 have received the message. The other laser tag guns 155 within the ad hoc network 151, upon receipt of the message from the sending laser tag gun 155, generate acknowledgement messages, which are broadcast over the ad hoc network 151 (FIG. 5 shows a protocol for receiving messages and generating acknowledgement messages). The sending laser tag gun 155 receives the acknowledgement messages 225 and maintains an acknowledgement record 227 indicating which of the other laser tag guns 155 have confirmed receipt of the sent message. The sending laser tag gun 155 also periodically checks the acknowledgement record 229 to determine if all other laser tag guns 155 have confirmed receipt of the sent message. The periodic checking of the acknowledgment record may be performed at any interval, although it is efficient to check the acknowledgement record each time it is updated in response to receiving a new acknowledgement message. In the event that the acknowledgement record indicates that all other laser tag guns 155 within the ad hoc network 151 have received the sent message, then the message is marked as sent 231. Once marked as sent, the message may be deleted unless a more permanent record of the game play and exchanged messages is desired. In the event that the acknowledgement record indicates that at least one of the other laser tag guns 155 within the ad hoc network 151 has not received the sent message, then the message is transmitted again 223 as a broadcast following a time interval. Retransmission of the message may occur at any desirable time interval. In certain embodiments, it may be beneficial to have each gun retransmit messages at randomly determined time intervals to help avoid undesirable congestion within the ad hoc network 151.

This sender-makes-right messaging protocol helps to ensure that when participating a laser tag gun 155 previously out of range (e.g., the laser tag guns 155 of the second or third groups 163, 165 of FIG. 2) comes back into range of other laser tag guns 155 (e.g., the laser tag guns 155 of the first group 161 of FIG. 2) of the ad hoc network 151, messages that were not previously received by the out-of-range laser tag guns 155 will be eventually sent and received by the previously out-of-range laser tag guns 155. By ensuring delivery of messages to previous out-of-range laser tag guns 155, game play can continue smoothly and without interruption due to one or more laser tag guns 155 going out of range.

A message receiving protocol 251 is shown in the flowchart of FIG. 5. This message receiving protocol is referred to as a “cascading retransmission” protocol, and it enables messages to travel from one end of the laser tag game space to the other even if the game space is larger than the transmission range of any of the laser tag guns 155. This range increasing effect compounds as a laser tag game has more participating laser tag guns 155, thereby permitting the size of the game space to be increased.

The message receiving protocol 251 starts upon receipt of a message 253 by a laser tag gun 155. Following receipt of the message 253, the laser tag gun 155 checks to determine if the message is the same as a previously received message 255. Within an ad hoc network, the laser tag guns 155 may conveniently attach a unique identifier to each message sent, so that all laser tag guns may easily track messages without having to retain the entire contents of messages after the contents have been processed. Also, by having unique identifiers associated with each message, a messaging protocol which calls for a receiving laser tag gun 151 to transmit a received message can avoid an infinite loop of rebroadcasting a message that is the same as a previously received message. In the event that the message was previously received, then the message may be processed 257 by deleting, and thereby effectively ignoring, the message. In the event that the message was not previously received, then the laser tag gun 155 transmits the message 259 through a broadcast on the ad hoc network 151, and the laser tag gun 155 also transmits an acknowledgment message 281 through a broadcast. The acknowledgement message 281 serves to notify the sending laser tag gun 155 that the sent message was received by the laser tag gun 155 sending the acknowledgment message 281.

As part of the message receiving protocol 251, receipt of acknowledgement messages are an exception. When an acknowledgement message is received, the receiving laser tag gun 155 processes the received acknowledgement without generating and transmitting an acknowledgment message in response.

In certain embodiments of the message receiving protocol 251, and for certain types of laser tag game play, the steps of checking if the message is the same as a previously received message 255, transmission of the message 259, and transmission of the acknowledgment message 281 may be omitted. In such embodiments, the message receiving protocol may proceed directly to the step of processing the message 257. In certain other embodiments, following the step of checking if the message is the same as a previously received message 255, one or both of the steps of transmission of the message 259 and transmission of the acknowledgment message 281 may be omitted. In the event both are omitted, other processing steps may be inserted following the step of checking if the message is the same as a previously received message 255.

In laser tag games, the messaging protocol 221 and the message receiving protocol 251 enable data to remain synchronized between all in-range laser tag guns 155, and they allow out of range laser tag guns 155 to synchronize once they come within range of other laser tag guns 155 within the ad hoc network 151. This enables scores to be dynamically and accurately updated in real time for each laser tag gun 155, providing all players with real-time game data so long as their laser tag guns 155 remain in range. In addition, through the use of these protocols within an ad hoc network, a laser tag game can be played anywhere, without the need for any infrastructure, such as a base station, to establish the network and manage the game play.

An alternative messaging protocol 271 is shown in the flowchart of FIG. 6. In this messaging protocol 271, acknowledgement messages need not be generated or recorded by any of the laser tag guns 155, as this messaging protocol 271 is intended to work both with and without the use of acknowledgement messages. This messaging protocol 271 may be used in conjunction with the sender-makes-right messaging protocol 221 of FIG. 4. As part of this messaging protocol 271, every sent message includes game score data, so that when a laser tag gun 155 receives a message with game score data 273, that game score data is compared with stored data 275, and particularly with stored game score data, from the memory of the receiving laser tag gun 155, and the stored data is updated 277 based on that comparison. In addition to normal messaging including game score data during a game, this messaging protocol 271 may also include the periodic exchange of messages for the sole purpose of synchronizing game score data, thereby enabling the participating laser tag guns 151 to better maintain synchronization of game score data during a game.

The following example of an implementation of the messaging protocol 271 is one in which game score data received with each message may be accurately updated without the use of acknowledgement messages, so that the game score remains synchronized amongst the participating laser tag guns 155. As part of this example of the messaging protocol 271, each laser tag gun 155 maintains record of the game score data in memory for all participating laser tag guns 155. The game score data may be stored as an array containing the last known score for every laser tag gun 155 participating in the laser tag game. Since each message sent by each laser tag gun 155 includes game score data, reflecting the last known game score stored in memory for the sending laser tag gun 155, all laser tag guns 155 receiving a message can compare the received game score data with the game score data stored in their own memory. With this comparison occurring upon the receipt of every message by a laser tag gun 155, the stored game score data can be frequently updated and synced with game score data stored and provided by other laser tag guns 155. As part of the comparison, each laser tag gun 155 compares every value in the array of received game score data with every corresponding value in the array of game score data stored in memory. For each value in the received game score data that is higher than the corresponding value in the stored game score data, the lower value in the stored game score data is replaced with the higher value from the received game score data. Thus, even if a laser tag gun 155 was previously out of range, scores for all laser tag guns may be easily and quickly updated when the previously out-of-range laser tag gun 155 returns to a communication range with other laser tag guns 155.

In furthering the above example of syncing game score data, a laser tag game may have three participating laser tag guns 155, listed as Unit A, Unit B, and Unit C. Table 1 below shows an example of game score data stored by two of the laser tag guns 155 (Unit A and Unit C), both of which are in range and in sync, and table 2 below shows an example of game score data stored by the third laser tag gun 155 (Unit B), which was previously out-of-range. Table 3 below then shows the game score data of all three laser tag guns 155 following Units A and C exchanging messages with previously out-of-range Unit B.

TABLE 1
game score data of in-range laser tag guns

| Unit | Score |
|---|---|
| Unit A | 2 |
| Unit B | 0 |
| Unit C | 2 |
| Total Score | 4 |

TABLE 2
game score data of out-of-range laser tag gun

| Unit | Score |
|---|---|
| Unit A | 1 |
| Unit B | 3 |
| Unit C | 1 |
| Total Score | 5 |

TABLE 3
synced game score data

| Unit | Score |
|---|---|
| Unit A | 2 |
| Unit B | 3 |
| Unit C | 2 |
| Total Score | 7 |

As can be seen in Table 3, the highest score reflected for each of the participating laser tag guns 155 in the arrays of Table 1 and Table 2 is used to create the array of Table 3. The synchronized game score data of Table 3 will be reflected in the stored data of all three laser tag guns 155 (Unit A, Unit B, Unit C) once Unit B receives a message from one of Units A or C, and once Unit A and Unit C receive a message from Unit B, and following the game score data comparisons performed by each laser tag gun 155.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A mobile device comprising:
a memory;
a wireless communication module configured to communicate within an ad hoc network with other mobile devices by wireless broadcasting;
a programmable processor operatively coupled to the memory and to the wireless communication module and configured to execute non-transitory computer-executable code, the code instructing the programmable processor to:
initiate an ad hoc network by self-identifying as a host device for the ad hoc network;
receive, through wireless broadcasting, one or more requests to join the ad hoc network from one or more participating mobile devices of the other mobile devices;
assign a unique identifier to each of the host device and the one or more participating mobile devices, the unique identifiers identifying the host device and the one or more participating mobile devices as network participants;
distribute to the one or more participating mobile devices, through wireless broadcasting, a list of the network participants, the list including the assigned unique identifiers;
confirm, through wireless broadcasting received from each of the one or more participating mobile devices, receipt of the participant list by each of the one or more participating mobile devices; and
designate to the one or more participating mobile devices, through wireless broadcasting, a data exchange protocol for the ad hoc network.

2. The mobile device of claim 1, wherein the code instructs the programmable processor to designate the data exchange protocol by distributing to the one or more participating mobile devices a protocol identifier to identify a data synchronization protocol.

3. The mobile device of claim 1, wherein the code instructs the programmable processor to designate the data exchange protocol by distributing a data synchronization protocol to the one or more participating mobile devices.

4. The mobile device of claim 1, wherein following establishment of the ad hoc network, the code further instructs the programmable processor to:
transmit a message through wireless broadcasting;
receive one or more receipt acknowledgement messages through wireless broadcasting in response to the transmitted message, each receipt acknowledgement message indicating receipt of the message by one of the other network participants;
maintain a record of received receipt acknowledgement messages; and
retransmit the message, through wireless broadcasting, following a time interval until the record indicates that the message has been received by each of the other network participants.

5. The mobile device of claim 4, wherein the time interval is a randomly determined time interval.

6. The mobile device of claim 1, wherein following receipt of the message, the code further instructs the programmable processor to:
receive a message through wireless broadcasting from one of the other network participants; and
transmit a receipt acknowledgement message through wireless broadcasting in response to a determination that the received message is not the same as a previously received message.

7. The mobile device of claim 1, wherein following establishment of the ad hoc network, the code further instructs the programmable processor to:
receive a message through wireless broadcasting from one of the other network participants; and
transmit the message through wireless broadcasting in response to a determination that the received message is not the same as a previously received message.

8. The mobile device of claim 1, wherein following establishment of the ad hoc network, the code further instructs the programmable processor to:
receive a message through wireless broadcasting from one of the other network participants, the message including game score data for each of the network participants; and
update stored data in the memory using the received game score data.

9. The mobile device of claim 8, wherein the stored data includes a first plurality of game scores for each of the network participants, the received game score data includes a second plurality of game scores for each of the network participants, and the stored data is updated to reflect a highest game score associated with each of the network participants as between the first plurality of game scores and the second plurality of game scores.

10. The mobile device of claim 1, wherein following establishment of the ad hoc network, the code further instructs the programmable processor to:
transmit messages through wireless broadcasting to the other network participants, each message including game score data.

11. The mobile device of claim 1, wherein each of the network participants comprises a laser tag gun, and each laser tag gun comprises a display operatively coupled to the programmable processor.

12. A method of establishing an ad hoc network amongst a plurality of mobile devices, each mobile device comprising a wireless communication module configured to enable communications through wireless broadcasting between at least any two of the plurality of mobile devices, the method comprising:
identifying a first mobile device among the plurality of mobile devices as a host device for the ad hoc network;
receiving, by the first mobile device through receipt of wireless broadcasting, a request to join the ad hoc network from one or more participating mobile devices of the plurality of mobile devices;
assigning, by the first mobile device, a unique identifier to each of the first mobile device and the one or more participating mobile devices, the unique identifiers identifying the first mobile device and the one or more participating mobile devices as network participants;
distributing to the one or more participating mobile devices, by the first mobile device through wireless broadcasting, a list of the network participants, the list including the assigned unique identifiers; and
confirming, by the first mobile device through wireless broadcasting received from each of the one or more participating mobile devices, receipt of the participant list by each of the one or more participating mobile devices; and
designating to the one or more participating mobile devices, through wireless broadcasting, a data exchange protocol for the ad hoc network.

13. The method of claim 12, wherein the first mobile device is identified as the host device of the ad hoc network in response to user input.

14. The method of claim 12, wherein designating the data exchange protocol includes distributing to the one or more participating mobile devices a protocol identifier to identify a data synchronization protocol.

15. The method of claim 12, wherein designating the data exchange protocol includes distributing a data synchronization protocol to the one or more participating mobile devices.

16. The method of claim 12, wherein each of the plurality of mobile devices comprises a laser tag gun, and each laser tag gun comprises a display operatively coupled to the programmable processor.

17. A mobile device comprising:
a memory;
a wireless communication module configured to communicate with other mobile devices by wireless broadcasting, the mobile device and the other mobile devices being configured to join an ad hoc network as network participants;
a programmable processor operatively coupled to the memory and to the wireless communication module and configured to execute non-transitory computer-executable code, wherein once joined in the ad hoc network, the code instructs the programmable processor to:
transmit a message to the other network participants of the ad hoc network through wireless broadcasting;
receive one or more receipt acknowledgement messages through wireless broadcasting in response to the transmitted message, each receipt acknowledgement message indicating receipt of the message by one of the other network participants;
maintain a record of received receipt acknowledgement messages; and
retransmit the message, through wireless broadcasting, following a time interval until the record indicates that the message has been received by each of the other network participants.

18. The mobile device of claim 17, wherein the time interval is a randomly determined time interval.

19. The mobile device of claim 17, wherein following receipt of the message, the code further instructs the programmable processor to:
receive a message through wireless broadcasting from one of the other network participants; and
transmit a receipt acknowledgement message through wireless broadcasting in response to a determination that the received message is not the same as a previously received message.

20. The mobile device of claim 17, wherein once joined in the ad hoc network, the code further instructs the programmable processor to:
receive a message through wireless broadcasting from one of the other network participants; and
transmit the message through wireless broadcasting in response to a determination that the received message is not the same as a previously received message.

21. The mobile device of claim 17, wherein once joined in the ad hoc network, the code further instructs the programmable processor to:
receive a message through wireless broadcasting from one of the other network participants, the message including game score data for each of the network participants; and
update stored data in the memory using the received game score data.

22. The mobile device of claim 21, wherein the stored data includes a first plurality of game scores for each of the network participants, the received game score data includes a second plurality of game scores for each of the network participants, and the stored data is updated to reflect a highest game score associated with each of the network participants as between the first plurality of game scores and the second plurality of game scores.

23. The mobile device of claim 17, wherein following establishment of the ad hoc network, the code further instructs the programmable processor to:
transmit messages through wireless broadcasting to the other network participants, each transmitted message including game score data.

24. The mobile device of claim 17, wherein each of the network participants comprises a laser tag gun, and each laser tag gun comprises a display operatively coupled to the programmable processor.
